(19) United States
(12) Patent Application Publication
(10) Pub. No.: US 2024/0305225 A1
(43) Pub. Date: Sep. 12, 2024

(54) MOTOR DRIVING DEVICE

(71) Applicant: Nuvoton Technology Corporation Japan, Kyoto (JP)

(72) Inventors: Daisuke FUKUDA, Kyoto (JP); Noriaki EMURA, Osaka (JP)

(21) Appl. No.: 18/658,498

(22) Filed: May 8, 2024

Related U.S. Application Data
(63) Continuation of application No. PCT/JP2022/040360, filed on Oct. 28, 2022.

(30) Foreign Application Priority Data
Nov. 26, 2021 (JP) 2021-192458

(51) Int. Cl. H02P 6/17; H02P 6/08; H02P 6/28

(52) U.S. Cl. CPC H02P 6/17; H02P 6/08; H02P 6/28

(57) ABSTRACT

A motor driving device includes: a rotor position detector that detects a rotor position of the motor; a first waveform generator that generates a first reference waveform based on the rotor position; a second waveform generator that generates a second reference waveform based on the rotor position, the second reference waveform being different from the first reference waveform; a waveform outputter that outputs, as an output waveform, the first reference waveform, the second reference waveform, or a composite waveform of the first reference waveform and the second reference waveform, based on the torque command value; and a current supplier that supplies, to the motor, a motor current generated based on the output waveform. In the motor driving device, the waveform outputter changes a composite ratio between the first reference waveform and the second reference waveform in the composite waveform, according to the torque command value.

### CROSS REFERENCE TO RELATED APPLICATIONS

This is a continuation application of PCT International Application No. PCT/JP2022/040360 filed on Oct. 28, 2022, designating the United States of America, which is based on and claims priority of Japanese Patent Application No. 2021-192458 filed on Nov. 26, 2021. The entire disclosures of the above-identified applications, including the specifications, drawings and claims are incorporated herein by reference in their entirety.

### FIELD

The present disclosure relates to a motor driving device.

### BACKGROUND

Conventionally, there is a known technique for switching the waveform of a current supplied to a motor to sinusoidal or quadrilateral waveform in a motor driving device that drives a motor (see, for example, Patent Literature (PTL) 1). In the motor driving device described in PTL 1, the waveform of the current supplied to the motor is shaped to include a quadrilateral waveform, thereby attempting to enable motor drive at a high speed of revolution and high torque.

### CITATION LIST

### Patent Literature

PTL 1: Japanese Unexamined Patent Application Publication No. 2004-180444

### SUMMARY

### Technical Problem

However, with the motor driving device described in PTL 1, there is a problem that the torque of the motor fluctuates abruptly when the waveform of the current is switched from a shape of a sinusoidal waveform to a shape including a quadrilateral waveform in order to increase the speed of revolution of the motor. There is also the problem of generation of noise and vibration associated with such torque fluctuations.

The present disclosure solves such problems, and provides a motor driving device that has a large range of the speed of revolution which allows driving and is capable of inhibiting abrupt fluctuations in torque due to a change in the speed of revolution.

### Solution to Problem

In order to solve the above-described problems, one aspect of the motor driving device according to the present disclosure is a motor driving device that drives a motor based on a torque command value. The motor driving device includes: a rotor position detector that detects a rotor position of the motor; a first waveform generator that generates a first reference waveform based on the rotor position; a second waveform generator that generates a second reference waveform based on the rotor position, the second reference waveform being different from the first reference waveform; a waveform outputter that outputs, as an output waveform, the first reference waveform, the second reference waveform, or a composite waveform of the first reference waveform and the second reference waveform, based on the torque command value; and a current supplier that supplies, to the motor, a motor current generated based on the output waveform. In the motor driving device, the waveform outputter changes a composite ratio between the first reference waveform and the second reference waveform in the composite waveform, according to the torque command value.

### Advantageous Effects

According to the present disclosure, it is possible to provide a motor driving device that has a large range of the speed of revolution which allows driving and is capable of inhibiting abrupt fluctuations in torque due to a change in the speed of revolution.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating a functional configuration of a motor driving device according to Embodiment 1.

FIG. 2 is a graph illustrating an example of the relationship between the proportion of a first reference waveform included in the waveform output by a waveform outputter and a torque command value, according to Embodiment 1.

FIG. 3 is a graph illustrating an example of the relationship between the amplitude of an output waveform that is output by the waveform outputter and a torque command value, according to Embodiment 1.

FIG. 4 is a graph illustrating an example of the first reference waveform according to Embodiment 1.

FIG. 5 is a graph illustrating an example of a composite waveform according to Embodiment 1.

FIG. 6 is a graph illustrating another example of the composite waveform according to Embodiment 1.

FIG. 7 is a graph illustrating yet another example of the composite waveform according to Embodiment 1.

FIG. 8 is a graph illustrating an example of a second reference waveform according to Embodiment 1.

FIG. 9 is a graph illustrating another example of the relationship between the proportion of the first reference waveform included in the waveform output by the waveform outputter and the torque command value, according to Embodiment 1.

FIG. 10 is a block diagram illustrating a configuration of a motor driving device according to Embodiment 2.

FIG. 11 is a block diagram illustrating a configuration of a motor driving device according to Embodiment 3.

FIG. 12 is a block diagram illustrating a configuration of a motor driving device according to Embodiment 4.

FIG. 13 is a graph illustrating an example of the relationship between an advance angle of a phase of an output waveform that is output by a waveform outputter of the motor driving device and a torque command value, according to Embodiment 4.

FIG. 14 is a block diagram illustrating a configuration of a motor driving device according to Embodiment 5.

### DESCRIPTION OF EMBODIMENTS

Hereinafter, embodiments of the present disclosure will be described with reference to the drawings. It should be noted that each of the embodiments described below shows a specific example of the present disclosure. Therefore, numerical values, shapes, materials, structural components, the arrangement and connection of the structural components, etc. indicated in the following embodiments are mere examples, and are not intended to limit the scope of the present disclosure.

In addition, each of the diagrams is a schematic diagram and thus is not necessarily strictly illustrated. Therefore, the scale sizes and the like are not necessarily exactly represented in each of the diagrams. In each of the diagrams, substantially the same structural components are assigned with the same reference signs, and redundant descriptions will be omitted or simplified.

### Embodiment 1

The following describes a motor driving device according to Embodiment 1.

### [1-1. Overall Configuration]

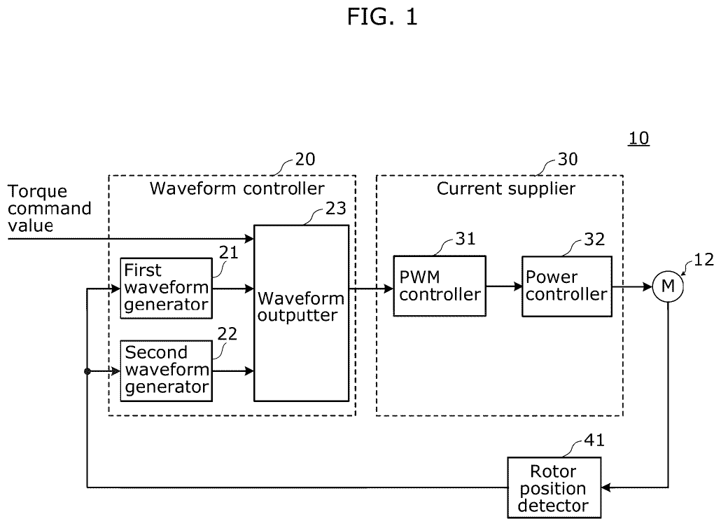

An overall configuration of the motor driving device according to the present embodiment will be described with reference to FIG. 1. FIG. 1 is a block diagram illustrating a functional configuration of motor driving device 10 according to the present embodiment. In FIG. 1, motor 12 that is driven by motor driving device 10 is also illustrated together with motor 12.

Motor driving device 10 is a device that drives motor 12, based on a torque command value. Motor driving device 10 supplies a current to motor 12 based on the torque command value, thereby rotating a rotor (not illustrated) that motor 12 includes. In the present embodiment, the torque command value is input from outside motor driving device 10. As illustrated in FIG. 1, motor driving device 10 includes waveform controller 20, current supplier 30, and rotor position detector 41.

Rotor position detector 41 is a detection device that detects a rotor position of motor 12. Rotor position detector 41 detects the rotor position (in other words, the rotational position of the rotor) using, for example, a Hall element, and outputs a pulse signal for each predetermined rotational angle. In the present embodiment, rotor position detector 41 outputs pulse signals to first waveform generator 21 and second waveform generator 22 provided in waveform controller 20.

Waveform controller 20 is a processing unit that controls the waveform of the current supplied to motor 12. Waveform controller 20 controls the waveform of the current supplied to motor 12, based on the torque command value and the rotor position detected by rotor position detector 41. In the present embodiment, waveform controller 20 includes first waveform generator 21, second waveform generator 22, and waveform outputter 23.

First waveform generator 21 is a processing unit that generates a first reference waveform. In the present embodiment, first waveform generator 21 generates the first reference waveform based on the rotor position detected by rotor position detector 41. The first reference waveform is a waveform of the current supplied by motor driving device 10 to motor 12, in a low-speed region in which the speed of revolution of motor 12 is relatively low. In the present embodiment, the first reference waveform is a sinusoidal waveform First waveform generator 21 detects the phase of the rotor and the speed of revolution per unit time, based on a pulse signal sequence output from rotor position detector 41, and determines a phase and a period of the first reference waveform, based on the phase and the speed of revolution of the rotor. First waveform generator 21 outputs a first reference waveform corresponding to the determined phase and period to waveform outputter 23. The first reference waveform is output as digital data, for example.

Second waveform generator 22 is a processing unit that generates a second reference waveform. In the present embodiment, second waveform generator 22 generates the second reference waveform that is different from the first reference waveform, based on the rotor position detected by rotor position detector 41. The second reference waveform is a waveform of the current supplied by motor driving device 10 to motor 12, in a high-speed region in which the speed of revolution of motor 12 is relatively high. In the present embodiment, the second reference waveform is a trapezoidal waveform. By using a trapezoidal waveform for the waveform of the current supplied to motor 12, motor 12 can be driven at higher revolution than when using a sinusoidal waveform, although the efficiency (ratio of the speed of revolution of the motor to the amount of currents supplied) of motor 12 decreases. It should be noted that the second reference waveform is not limited to the trapezoidal waveform. For example, the second reference waveform may be a quadrilateral waveform or the like. Second waveform generator 22 detects the phase and the speed of revolution per unit time of the rotor, based on a pulse signal sequence output from rotor position detector 41, and determines a phase and a period of the second reference waveform, based on the phase and the speed of revolution of the rotor. Second waveform generator 22 outputs a second reference waveform corresponding to the determined phase and period to waveform outputter 23. The second reference waveform is output as digital data, for example.

Waveform outputter 23 is a processing unit that outputs a first reference waveform, a second reference waveform, or a composite waveform of the first reference waveform and the second reference waveform, as an output waveform, based on the torque command value. Waveform outputter 23 obtains the first reference waveform from first waveform generator 21 and the second reference waveform from second waveform generator 22. Waveform outputter 23 outputs the output waveform to pulse width modulation (PWM) controller 31 of current supplier 30. The detailed operation of waveform outputter 23 will be described below.

Current supplier 30 supplies a motor current generated based on the output waveform output from waveform outputter 23, to motor 12. In the present embodiment, current supplier 30 includes PWM controller 31 and power controller 32.

PWM controller 31 is a processing unit that outputs a PWM signal based on the output waveform output from waveform outputter 23. The PWM signal output by PWM controller 31 corresponds to the energization period of a switching transistor that power controller 32 includes. PWM controller 31 modulates a duty ratio of the PWM signal to be output, according to the output waveform output by waveform outputter 23.

Power controller 32 is a circuit that supplies a current to motor 12 based on the PWM signal output by PWM controller 31. Power controller 32, for example, includes a bridge circuit that includes a plurality of pairs of series circuits of a high-side switching transistor and a low-side switching transistor, and motor 12 is connected to a middle connecting point of each of the series circuits. The PWM signal output from PWM controller 31 is input to each of the switching transistors. As a result, each of the switching transistors is energized for the energization period corresponding to the PWM signal. It is thus possible to supply a current having the waveform corresponding to the PWM signal, i.e., a current having the waveform corresponding to the output waveform of waveform outputter 23, to motor 12.

### [1-2. Operation of Waveform Outputter]

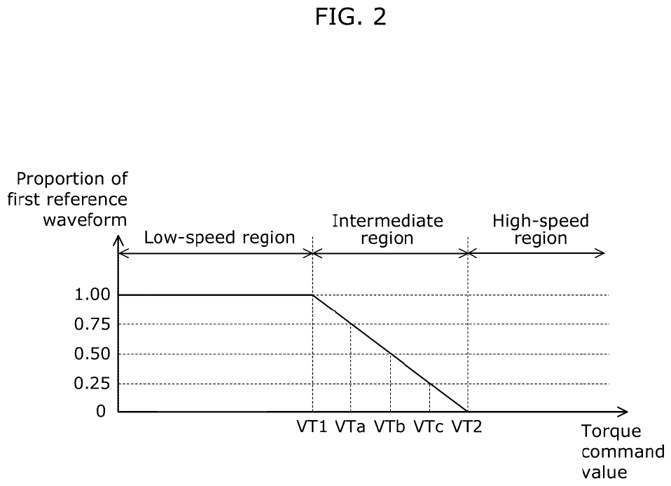

The following describes the operation of waveform outputter 23 according to the present embodiment. First, the waveform output by waveform outputter 23 will be described with reference to FIG. 2.

FIG. 2 is a graph illustrating an example of the relationship between the proportion of the first reference waveform included in a waveform output by waveform outputter 23 and a torque command value, according to the present embodiment. As illustrated in FIG. 2, waveform outputter 23 outputs a first reference waveform when the torque command value is less than lower composite limit VT1, that is, when the torque command value is in the low-speed region. Waveform outputter 23 outputs a second reference waveform when the torque command value is greater than upper composite limit VT2, that is, when the torque command value is in the high-speed region. Waveform outputter 23 outputs a composite waveform of the first reference waveform and the second reference waveform when the torque command value is greater than or equal to the lower composite limit and less than or equal to the upper composite limit, that is, when the torque command value is in an intermediate region.

When the torque command value is in the intermediate region, waveform outputter 23 changes the proportion of the first reference waveform in the composite waveform, in other words, the composite ratio between the first reference waveform and the second reference waveform, according to the torque command value, as illustrated in FIG. 2. Waveform outputter 23 generates the composite waveform by performing a weighted average on all phases of the first reference waveform and the second reference waveform. In other words, the composite waveform is generated by multiplying each of the values of the first reference waveform and the second reference waveform in each phase by a weight coefficient corresponding to the composite ratio, and adding up the results of the multiplication. Waveform outputter 23 changes the composite ratio by changing the weight coefficient by which each reference waveform is multiplied, according to the torque command value.

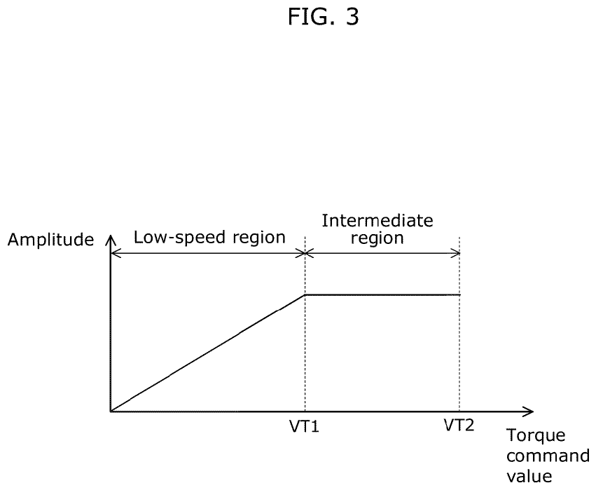

waveform outputter 23 further changes the amplitude of the output waveform according to the torque command value. The amplitude of the output waveform output by waveform outputter 23 will be described with reference to FIG. 3. FIG. 3 is a graph illustrating an example of the relationship between the amplitude of an output waveform that is output by waveform outputter 23 and a torque command value, according to the present embodiment. As illustrated in FIG. 3, for example, waveform outputter 23 changes the amplitude of the first reference waveform according to the torque command value when the torque command value is less than lower composite limit VT1. With this, it is possible to change the amount of currents supplied from power controller 32 to motor 12. As a result, it is possible to change the speed of revolution of motor 12. More specifically, waveform outputter 23 increases the amplitude of the output waveform as the torque command value increases in the low-speed region.

In addition, in the present embodiment, waveform outputter 23 keeps the amplitude constant in the intermediate region, as illustrated in FIG. 3. It should be noted that waveform outputter 23 may increase the amplitude of the output waveform as the torque command value increases, in the intermediate region as well as in the low-speed region. In addition, although not illustrated in FIG. 3, waveform outputter 23 may change the amplitude of the second reference waveform according to the torque command value in the high-speed region.

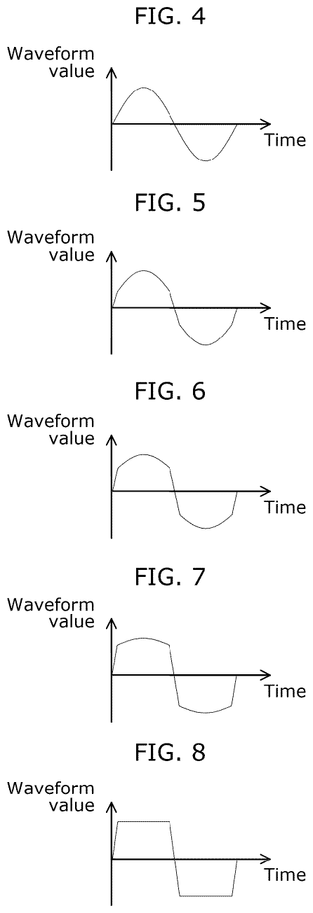

Next, examples of the first reference waveform, the second reference waveform, and the composite waveform will be described with reference to FIG. 4 to FIG. 8. FIG. 4 is a graph illustrating an example of the first reference waveform according to the present embodiment. Each of FIG. 5 to FIG. 7 is a graph illustrating an example of the composite waveform according to the present embodiment. FIG. 8 is a graph illustrating an example of the second reference waveform according to the present embodiment. The horizontal axis in each of FIG. 4 to FIG. 8 represents the time, and the vertical axis represents the value (waveform value) indicated by each waveform.

As illustrated in FIG. 4 and FIG. 8, in the present embodiment, the first reference waveform and the second reference waveform are a sinusoidal waveform and a trapezoidal waveform, respectively. When such first reference waveform and second reference waveform are used, waveform outputter 23 outputs the composite waveforms illustrated in FIG. 5, FIG. 6, and FIG. 7 at torque command values VTa, Vtb, and VTc illustrated in FIG. 2, respectively.

In the composite waveform illustrated in FIG. 5, the composite ratio of the first reference waveform to the second reference waveform is 75:25 (i.e., 3:1). When the torque command value is VTa, waveform outputter 23 generates the composite waveform illustrated in FIG. 5 by adding up the value of the first reference waveform multiplied by 0.75 as the weight coefficient and the value of the second reference waveform multiplied by 0.25 as the weight coefficient.

In the composite waveform illustrated in FIG. 6, the composite ratio of the first reference waveform to the second reference waveform is 50:50 (i.e., 1:1). When the torque command value is VTb, waveform outputter 23 generates the composite waveform illustrated in FIG. 6 by adding up the value of the first reference waveform multiplied by 0.50 as the weight coefficient and the value of the second reference waveform multiplied by 0.50 as the weight coefficient.

In the composite waveform illustrated in FIG. 7, the composite ratio of the first reference waveform to the second reference waveform is 25:75 (i.e., 1:3). When the torque command value is VTc, waveform outputter 23 generates the composite waveform illustrated in FIG. 7 by adding up the value of the first reference waveform multiplied by 0.25 as the weight coefficient and the value of the second reference waveform multiplied by 0.75 as the weight coefficient.

As described above, waveform outputter 23 according to the present embodiment is capable of outputting the first reference waveform suitable for the low-speed region and the second reference waveform suitable for the high-speed region. Accordingly, motor driving device 10 according to the present embodiment is capable of expanding the range of the speed of revolution which allows driving motor 12, compared to a motor driving device that uses only one reference waveform.

Furthermore, in the intermediate region, waveform outputter 23 according to the present embodiment changes the composite ratio between the first reference waveform and the second reference waveform in the composite waveform, according to the torque command value. With this, as illustrated in FIG. 4 to FIG. 8, it is possible to inhibit the shape of the composite waveform from changing abruptly in response to a change in the torque command value. Accordingly, the abrupt change in the waveform of the current supplied from motor driving device 10 to motor 12 can be inhibited, and thus it is possible to inhibit abrupt fluctuations in torque due to a change in the torque command value (i.e., change in the speed of revolution of motor 12). As a result, it is possible to inhibit noise and vibration generated from motor 12.

In the present embodiment, as illustrated in FIG. 2, waveform outputter 23 continuously changes the composite ratio of the composite waveform according to the torque command value in the intermediate region. With this, it is possible to further inhibit an abrupt change in the waveform of the current supplied from motor driving device 10 to motor 12, and thus abrupt fluctuations in torque due to a change in the speed of revolution of motor 12 can further be inhibited. As a result, it is possible to further inhibit noise and vibration generated from motor 12.

Here, the configuration in which the composite ratio is caused to change continuously includes a configuration in which the composite ratio is caused to change substantially continuously. For example, of a configuration in which the ratio of the first reference waveform or the second reference waveform included in the composite waveform changes discretely (i.e., in a stepwise manner) according to the torque command value that continuously changes, a configuration in which the minimum amount of change in the ratio that changes discretely is sufficiently small is also included in the configuration in which the composite ratio is caused to change substantially continuously. For example, a configuration in which the minimum amount of change in the ratio that changes discretely is less than or equal to 5% is also included in the configuration in which the composite ratio is caused to change substantially continuously.

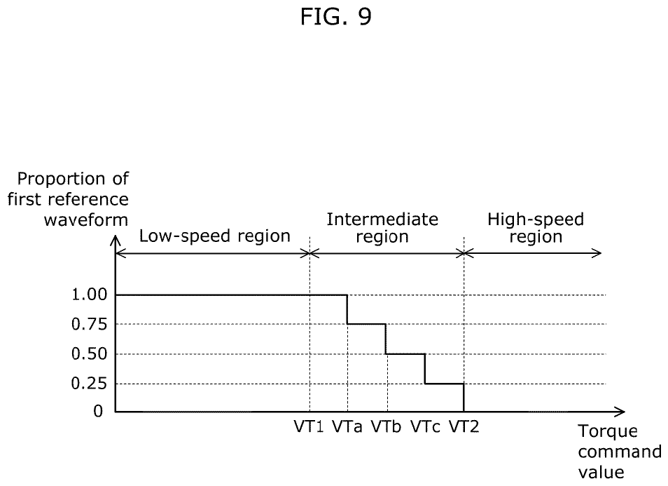

It should be noted that the manner of the change of the composite ratio between the first reference waveform and the second reference waveform in the composite waveform output by waveform outputter 23 is not limited to the example illustrated in FIG. 2. Other examples of the manner of the change of the composite ratio will be explained with reference to FIG. 9. FIG. 9 is a graph illustrating another example of the relationship between the ratio of the first reference waveform included in a waveform output by waveform outputter 23 and a torque command value, according to the present embodiment.

As illustrated in FIG. 9, waveform outputter 23 may change the composite ratio between the first reference waveform and the second waveform in the composite waveform, to different values in a stepwise manner, according to the torque command value. In the example illustrated in FIG. 9, the composite ratio is changed in three stages in a stepwise manner. In such a configuration as well, it is possible to inhibit the shape of the composite waveform from changing abruptly in response to a change in the torque command value. Accordingly, the abrupt change in the waveform of the current supplied from motor driving device 10 to motor 12 can be inhibited, and thus it is possible to inhibit the abrupt fluctuations of the torque in response to a change in the speed of revolution of motor 12.

### Embodiment 2

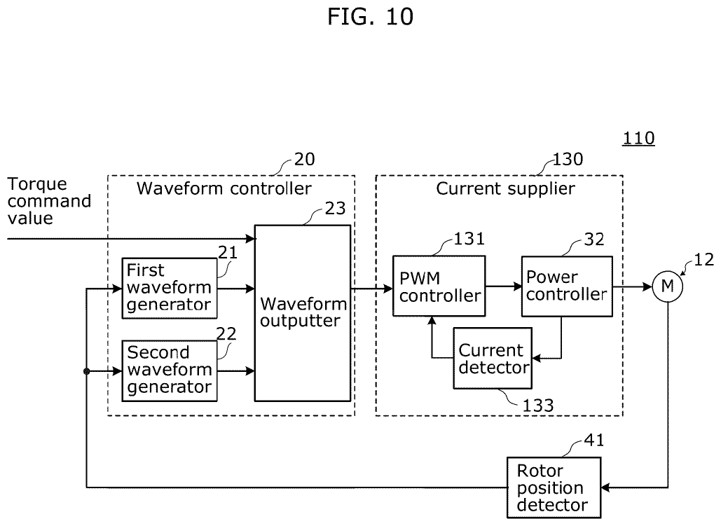

The following describes a motor driving device according to Embodiment 2. The motor driving device according to the present embodiment differs from motor driving device 10 according to Embodiment 1 in the configuration of the current supplier. The following describes the motor driving device according to the present embodiment, focusing on the differences from motor driving device 10 according to Embodiment 1, with reference to FIG. 10.

FIG. 10 is a block diagram illustrating a configuration of motor driving device 110 according to the present embodiment. As illustrated in FIG. 10, motor driving device 110 includes waveform controller 20, current supplier 130, and rotor position detector 41.

Current supplier 130 according to the present embodiment includes PWM controller 131, power controller 32, and current detector 133.

Current detector 133 is a detection device that detects a motor current supplied from power controller 32 to motor 12. Current detector 133 outputs the waveform of the detected motor current to PWM controller 131. Current supplier 130 according to the present embodiment controls the motor current detected by current detector 133 to approximate a waveform of the motor current to the output waveform output by waveform outputter 23. In other words, current supplier 130 performs feedback control on a motor current based on the waveform of the motor current detected by current detector 133.

PWM controller 131 according to the present embodiment controls a PWM signal to approximate a waveform of the motor current detected by current detector 133 to the output waveform output by waveform outputter 23. More specifically, PWM controller 131 controls a duty ratio of each pulse of the PWM signal. PWM controller 131, for example, may perform the Proportional-Integral-Differential (PID) control.

The same advantageous effects as those of motor driving device 10 according to Embodiment 1 can also be yielded by motor driving device 110 according to the present embodiment.

Furthermore, in motor driving device 110 according to the present embodiment, a motor current detected by current detector 133 is controlled to approximate a waveform of the motor current to the output waveform output by waveform outputter 23. In this manner, the waveform of the motor current can be more approximated to the output waveform, and thus it is possible to reduce the difference between the waveform of the motor current and the output waveform. As a result, it is possible to inhibit the abrupt fluctuation of the torque due to an increase in the difference between the waveform of the motor current and the output waveform.

### Embodiment 3

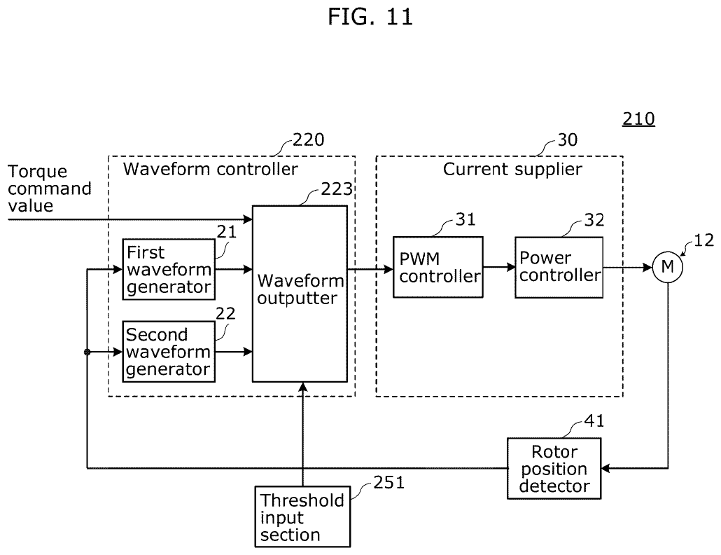

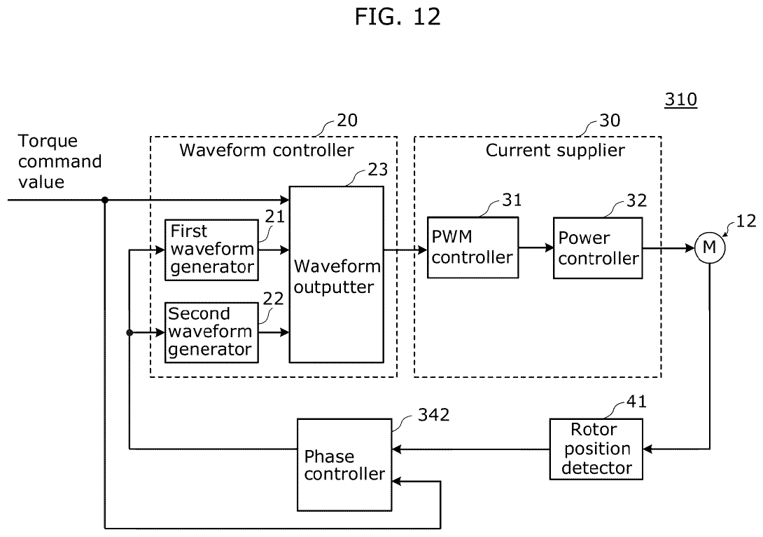

A motor driving device according to Embodiment 3 will be described. The motor driving device according to the present embodiment differs from motor driving device 10 according to Embodiment 1 in the configuration of the waveform outputter. The following describes the motor driving device according to the present embodiment, focusing on the differences from motor driving device 10 according to Embodiment 1, with reference to FIG. 11.

FIG. 11 is a block diagram illustrating a configuration of motor driving device 210 according to the present embodiment. As illustrated in FIG. 11, motor driving device 210 includes waveform controller 220, current supplier 30, rotor position detector 41, and threshold input section 251.

Threshold input section 251 is an input section that provides waveform controller 220 with a threshold pertaining to the intermediate region, as an input received by waveform controller 220. In the present embodiment, threshold input section 251 provides a lower-limit setting value corresponding to a lower composite limit and an upper-limit setting value corresponding to an upper composite limit, to waveform outputter 223 of waveform controller 220. It should be noted that, when waveform outputter 223 changes, according to the torque command value, the composite ratio between the first reference waveform and the second waveform in the composite waveform to different values in a stepwise manner, threshold input section 251 may provide a threshold of each step and a composite ratio of each step.

Waveform controller 220 according to the present embodiment includes first waveform generator 21, second waveform generator 22, and waveform outputter 223.

Waveform outputter 223 according to the present embodiment receives, as inputs, the lower-limit setting value and the upper-limit setting value from threshold input section 251. Waveform outputter 223 sets a lower composite limit based on the lower-limit setting value provided by threshold input section 251, and sets an upper composite limit based on the upper-limit setting value provided by threshold input section 251.

With motor driving device 210 according to the present embodiment, it is possible to change a lower composite limit and an upper composite limit by changing the lower-limit setting value and the upper-limit setting value which are provided by threshold input section 251. Accordingly, it is possible to adjust the relationship between the torque command value and the output waveform according to the characteristics of motor 12 or the like. As a result, waveform controller 220 is capable of outputting to current supplier 30 an output waveform suitable for the characteristics of motor 12 and the torque command value.

It should be noted that, although motor driving device 210 includes threshold input section 251 in the present embodiment, motor driving device 210 may be implemented without including threshold input section 251. For example, motor driving device 210 may receive, as an input, each threshold from an external input device.

### Embodiment 4

A motor driving device according to Embodiment 4 will be described. The motor driving device according to the present embodiment differs from motor driving device 10 according to Embodiment 1 in that the phase of an output waveform is controlled. The following describes the motor driving device according to the present embodiment, focusing on the differences from motor driving device 10 according to Embodiment 1, with reference to FIG. 12.

FIG. 12 is a block diagram illustrating a configuration of motor driving device 310 according to the present embodiment. As illustrated in FIG. 12, motor driving device 310 includes waveform controller 20, current supplier 30, rotor position detector 41, and phase controller 342.

Phase controller 342 is a processing unit which receives, as an input, a torque command value and changes the phase difference between the rotor position detected by rotor position detector 41 and an output waveform, based on the torque command value. In the present embodiment, phase controller 342 receives, as an input, a rotor position detected by rotor position detector 41. Phase controller 342 delays the received rotor position according to the torque command value, and outputs it to first waveform generator 21 and second waveform generator 22 of waveform controller 20. In this manner, the phase of the rotor position is controlled, and thus it is possible to control the phase difference between the rotor position and the output waveform output from waveform outputter 23.

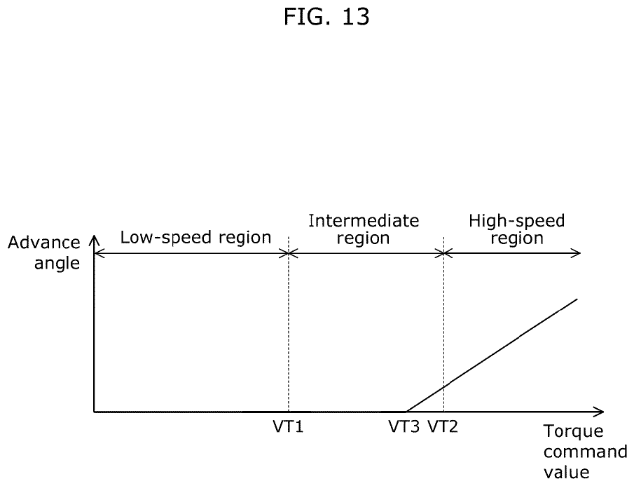

Here, the relationship between the phase of the output waveform of motor driving device 310 and the torque command value will be described with reference to FIG. 13. FIG. 13 is a graph illustrating an example of the relationship between an advance angle of the phase of an output waveform output by waveform outputter 23 of motor driving device 310 and a torque command value according to the present embodiment.

As illustrated in FIG. 13, in the high-speed region, the advance angle of the output waveform increases as the torque command value increases. By increasing the advance angle of the output waveform, it is possible to drive motor 12 at a higher speed of revolution. In the present embodiment, phase controller 342 changes the rotor position, output waveform, and phase difference when the torque command value is greater than or equal to phase change threshold VT3. As illustrated in FIG. 13, phase change threshold VT3 is greater than or equal to lower composite limit VT1 and less than or equal to upper composite limit VT2. Since phase change threshold VT3 is less than or equal to upper composite limit VT2, phase controller 342 is capable of controlling the phase difference in the high-speed region, and thus motor driving device 310 is capable of driving motor 12 at a higher speed of revolution in the high-speed region. In addition, since phase change threshold VT3 is greater than or equal to lower composite limit VT1, it is possible to enhance the efficiency of motor driving device 310 with the advance angle value being zero, in the low-speed region.

### Embodiment 5

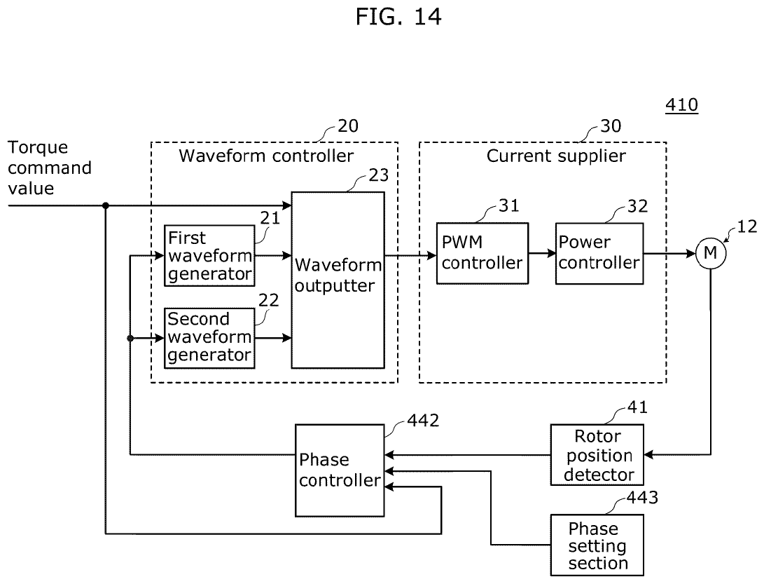

A motor driving device according to Embodiment 5 will be described. The motor driving device according to the present embodiment differs from motor driving device 310 according to Embodiment 4 in that it is possible to change the relationship between the phase difference between the output waveform and the rotor position and the torque command value. The following describes the motor driving device according to the present embodiment, focusing on the differences from motor driving device 310 according to Embodiment 4, with reference to FIG. 14.

FIG. 14 is a block diagram illustrating a configuration of motor driving device 410 according to the present embodiment. As illustrated in FIG. 14, motor driving device 410 includes waveform controller 20, current supplier 30, rotor position detector 41, phase controller 442, and phase setting section 443.

Phase setting section 443 is a setting section that sets a phase difference between the rotor position detected by rotor position detector 41 and an output waveform output by waveform outputter 23, by providing phase controller 442 with phase setting information that is information pertaining to the phase difference. The phase setting information includes, for example, phase change threshold VT3 (see FIG. 13). The phase setting information may further include a rate of change in the advance angle value with respect to a torque command value (i.e., the slope of the graph illustrated in FIG. 13) when the torque command value is greater than or equal to the phase change threshold.

Phase controller 442 according to the present embodiment receives, as an input, the phase setting information from phase setting section 443. Phase controller 442 sets the relationship between the torque command value and the phase difference between the output waveform and the rotor position, based on the phase setting information received.

In this manner, the phase setting information that phase controller 442 receives as an input from phase setting section 443 is changed, thereby making it possible to adjust the relationship between the torque command value and the advance angle value as illustrated in FIG. 13. Accordingly, it is possible to adjust the relationship between the torque command value and the advance angle value according to the characteristics of motor 12 or the like.

It should be noted that, although motor driving device 410 includes phase setting section 443 in the present embodiment, motor driving device 410 may be implemented without including phase setting section 443. For example, motor driving device 410 may receive, as an input, phase setting information from an external input device.

### (Variation, Etc.)

Although the present disclosure has been described based on the embodiments thus far, the present disclosure is not limited to the embodiments described above.

In addition, forms obtained by various modifications to the respective exemplary embodiments described above that can be conceived by a person of skill in the art as well as forms realized by arbitrarily combining structural components and functions in the respective exemplary embodiments described above which are within the scope of the essence of the present disclosure are also included in the present disclosure.

### INDUSTRIAL APPLICABILITY

The motor driving device according to the present disclosure is applicable, for example, to motors for various applications as a motor driving device that is capable of inhibiting noise and vibration of motors.

1. A motor driving device that drives a motor based on a torque command value, the motor driving device comprising:
a rotor position detector that detects a rotor position of the motor;
a first waveform generator that generates a first reference waveform based on the rotor position;
a second waveform generator that generates a second reference waveform based on the rotor position, the second reference waveform being different from the first reference waveform;
a waveform outputter that outputs, as an output waveform, the first reference waveform, the second reference waveform, or a composite waveform of the first reference waveform and the second reference waveform, based on the torque command value; and
a current supplier that supplies, to the motor, a motor current generated based on the output waveform, wherein
the waveform outputter changes a composite ratio between the first reference waveform and the second reference waveform in the composite waveform, according to the torque command value.

2. The motor driving device according to claim 1, wherein
the current supplier further includes a current detector that detects the motor current, and
the current supplier controls the motor current detected by the current detector to approximate a waveform of the motor current to the output waveform.

3. The motor driving device according to claim 1, wherein
the waveform outputter:
outputs the first reference waveform when the torque command value is less than a lower composite limit;
outputs the second reference waveform when the torque command value is greater than an upper composite limit; and
outputs the composite waveform when the torque command value is greater than or equal to the lower composite limit and less than or equal to the upper composite limit.

4. The motor driving device according to claim 3, wherein
the waveform outputter receives, as an input, a lower-limit setting value corresponding to the lower composite limit, and
the waveform outputter sets the lower composite limit based on the lower-limit setting value.

5. The motor driving device according to claim 3, wherein
the waveform outputter changes an amplitude of the first reference waveform according to the torque command value when the torque command value is less than the lower composite limit.

6. The motor driving device according to claim 1, wherein
the first reference waveform is a sinusoidal waveform.

7. The motor driving device according to claim 1, wherein
the second reference waveform is a trapezoidal waveform.

8. The motor driving device according to claim 1, wherein
the waveform outputter changes the composite ratio between the first reference waveform and the second reference waveform in the composite waveform, to different values in a stepwise manner according to the torque command value.

9. The motor driving device according to claim 1, further comprising:
a phase controller that receives, as an input, the torque command value, and changes a phase difference between the rotor position and the output waveform, based on the torque command value.

10. The motor driving device according to claim 9, wherein
the phase controller receives, as an input, phase setting information pertaining to the phase difference, and
the phase controller sets a relationship between the torque command value and the phase difference, based on the phase setting information.

11. The motor driving device according to claim 3, further comprising:
a phase controller that receives, as an input, the torque command value, and changes a phase difference between the rotor position and the output waveform, based on the torque command value, wherein
the phase controller changes the phase difference when the torque command value is greater than or equal to a phase change threshold, and
the phase change threshold is greater than or equal to the lower composite limit and less than or equal to the upper composite limit.

12. The motor driving device according to claim 1, wherein
the waveform outputter generates the composite waveform by performing weighted average on all phases of the first reference waveform and the second reference waveform.
